(19) United States
(12) Patent Application Publication
(10) Pub. No.: US 2020/0213100 A1
(43) Pub. Date: Jul. 2, 2020

(54) MULTI-CHAIN INFORMATION MANAGEMENT METHOD, STORAGE MEDIUM AND BLOCKCHAIN IDENTITY PARSER

(71) Applicant: SHENZHEN LIANBAO TECHNOLOGY CO., LTD., Nanshan District, Shenzhen, Guangdong (CN)

(72) Inventors: Quan Zhang, Shenzhen, Guangdong (CN); Bo Zhu, Shenzhen, Guangdong (CN)

(21) Appl. No.: 16/323,302

(22) PCT Filed: Nov. 27, 2018
(86) PCT No.: PCT/CN2018/117732

§ 371 Date: Feb. 5, 2019

(51) Int. Cl. H04L 9/08; G06F 16/27; H04L 9/30

(52) U.S. Cl. CPC H04L 9/088; H04L 9/30; G06F 16/27

(57) ABSTRACT

In the present disclosure, it is provided a multi-chain information management method, apparatus, storage medium, and blockchain identity parser, including: acquiring application information submitted by a user, where the application information includes identity information; creating a management account for the user according to the application information and generating account information of the management account; acquiring account information of a blockchain account of the user corresponding to the identity information in a blockchain; and storing the account information of the blockchain account and the account information of the management account in a correlated manner, enabling the user to manage the blockchain account according to the management account. The present disclosure can facilitate the user to manage the account information in multiple blockchains, reduce the burden of the user to memorize the account information on each blockchain, and improve the efficiency of the operation of the user to multiple blockchains.

### TECHNICAL FIELD

The present disclosure relates to the field of blockchain technology, and in particular, to a multi-chain information management method, device, storage medium, and blockchain identity parser.

### BACKGROUND

With the development of the Internet and e-commerce, computer network applications have penetrated into all walks of life, and global informationization has become a major trend in human development. Blockchain is a new application mode of computer technology such as distributed data storage, point-to-point transmission, consensus mechanism, and encryption algorithm. Due to the stability and reliability of blockchain data, the development and the application of blockchain has become a trend of informatization development.

In the blockchain ecosystem, an increasingly inevitable problem is the existence of more and more blockchain networks. At present, the blockchain has its own identity verification mechanism. The user needs to store and manage the identity information for the blockchain. If the user uses multiple blockchains, the user needs to memorize the identity information for each chain, which is more difficult and is easy to make mistakes when transaction is performed, resulting in inefficient operation.

### SUMMARY

### Technical Problem

According to embodiments of the present disclosure, it is provided a multi-chain information management method, apparatus, storage medium, and blockchain identity parser, aiming to solve the problem in the prior art that, if a user uses multiple blockchains, the user needs to memorize the identity information for each chain, which is more difficult and is easy to make mistakes when transaction is performed, resulting in inefficient operation.

### Technical Solution

According to a first aspect of embodiments of the present disclosure, it is provided a multi-chain information management method for a blockchain identity parser, including:

acquiring application information submitted by a user, where the application information includes identity information;

creating a management account for the user according to the application information and generating account information of the management account;

acquiring account information of a blockchain account of the user corresponding to the identity information in a blockchain; and

storing the account information of the blockchain account and the account information of the management account in a correlated manner, enabling the user to manage the blockchain account according to the management account.

According to a second aspect of embodiments of the present disclosure, it is provided a multi-chain information management method for a blockchain, including:

receiving a blockchain account creation request of a user, where the blockchain account creation request carries a blockchain account application information of the user, and the blockchain account application information includes an identity identifier;

creating a blockchain account in the blockchain for the user according to the blockchain account application information; and

sending account information of the blockchain account to a blockchain identity parser corresponding to the identity identifier according to the identity identifier in the blockchain account application information, enabling the blockchain identity parser to store the account information of the blockchain account and account information of a management account of the user in the blockchain identity parser in a correlated manner.

According to a third aspect of embodiments of the present disclosure, it is provided a multi-chain information management apparatus for a blockchain identity parser, including:

a first application information acquisition unit configured to acquire application information submitted by a user, where the application information includes identity information;

a management account generation unit configured to create a management account for the user according to the application information and generating account information of the management account;

a first information acquisition unit configured to acquire account information of a blockchain account of the user corresponding to the identity information in a blockchain; and

a first information processing unit configured to store the account information of the blockchain account and the account information of the management account in a correlated manner, enabling the user to manage the blockchain account according to the management account.

According to a fourth aspect of embodiments of the present disclosure, it is provided a multi-chain information management apparatus for a blockchain, including:

a second application information acquisition unit configured to receive a blockchain account creation request of a user, where the blockchain account creation request carries a blockchain account application information of the user, and the blockchain account application information includes an identity identifier;

a blockchain account generation unit configured to create a blockchain account in the blockchain for the user according to the blockchain account application information; and

a second information processing unit configured to send account information of the blockchain account to a blockchain identity parser corresponding to the identity identifier according to the identity identifier in the blockchain account application information, enabling the blockchain identity parser to store the account information of the blockchain account and account information of a management account of the user in the blockchain identity parser in a correlated manner.

According to a fifth aspect of embodiments of the present disclosure, it is provided a blockchain identity parser, including a first memorizer, a first processor and a first computer program stored in the first memorizer and operable in the first processor, where the first processor is configured to implement steps of the multi-chain information management method according to the above described first aspect when the first processor executes the first computer program.

According to a sixth aspect of embodiments of the present disclosure, it is provided a server, including a second memorizer, a second processor and a second computer program stored in the second memorizer and operable in the second processor, where the second processor is configured to implement steps of the multi-chain information management method according to the above described second aspect when the second processor executes the second computer program.

According to a seventh aspect of embodiments of the present disclosure, it is provided a computer readable and writable storage medium with a first computer program stored therein, where when the first computer program is executed by a first processor, steps of the multi-chain information management method according to the above described first aspect are implemented.

According to a eighth aspect of embodiments of the present disclosure, it is provided a computer readable and writable storage medium with a second computer program stored therein, where when the second computer program is executed by a second processor, steps of the multi-chain information management method according to the above described second aspect are implemented.

### Beneficial Effect

It can be seen that, in some embodiments of the present disclosure, the application information including the identity information submitted by the user is acquired, the management account is created for the user according to the application information, the account information of the management account is generated, the account information of the blockchain account of the user in the blockchain corresponding to the identity information is acquired, and the account information of the blockchain account and the account information of the management account are stored in a correlated manner, enabling the user to manage the blockchain account according to the management account. The user only needs to memorize the account information of the management account, and does not need to separately memorize the account information in respective blockchains, thereby reducing the burden of the user and improving the efficiency of the operation of the user to the blockchain.

### BRIEF DESCRIPTION OF THE DRAWINGS

In order to more clearly illustrate the technical solutions in the embodiments of the present disclosure, the drawings used in the description to the embodiments or the prior art will be briefly described below. It is obvious that the drawings in the following description are just for some embodiments of the present disclosure, those skilled in the art can also obtain other drawings based on these drawings without paying any creative effort.

FIG. 1 is a flowchart of implementing a multi-chain information management method according to an embodiment of the present disclosure;

FIG. 1.1 is a schematic flowchart of generating a public key and an address in a multi-chain information management method according to an embodiment of the present disclosure;

FIG. 2 is a flowchart of implementing another multi-chain information management method according to an embodiment of the present disclosure;

FIG. 3 is a schematic diagram of an interaction process of a multi-chain information management method according to an embodiment of the present disclosure;

FIG. 4 is a block diagram of a multi-chain information management apparatus according to an embodiment of the present disclosure;

FIG. 5 is a block diagram of another multi-chain information management apparatus according to an embodiment of the present disclosure;

FIG. 6 is a schematic diagram of a blockchain identity parser according to an embodiment of the present disclosure; and

FIG. 7 is a schematic diagram of a server according to an embodiment of the present disclosure.

### DESCRIPTION OF THE EMBODIMENTS

In order to make the object, the features and the advantages of the present disclosure more obvious and easy to understand, the technical solutions in the embodiments of the present disclosure will be clearly and completely described below with reference to the accompanying drawings in the embodiments of the present disclosure. It is obvious that embodiments are to be described are just some instead of all embodiments of the present disclosure. All other embodiments obtained by those skilled in the art based on the embodiments of the present disclosure without paying any creative effort should be included within the protection scope of the present disclosure.

### Embodiment 1

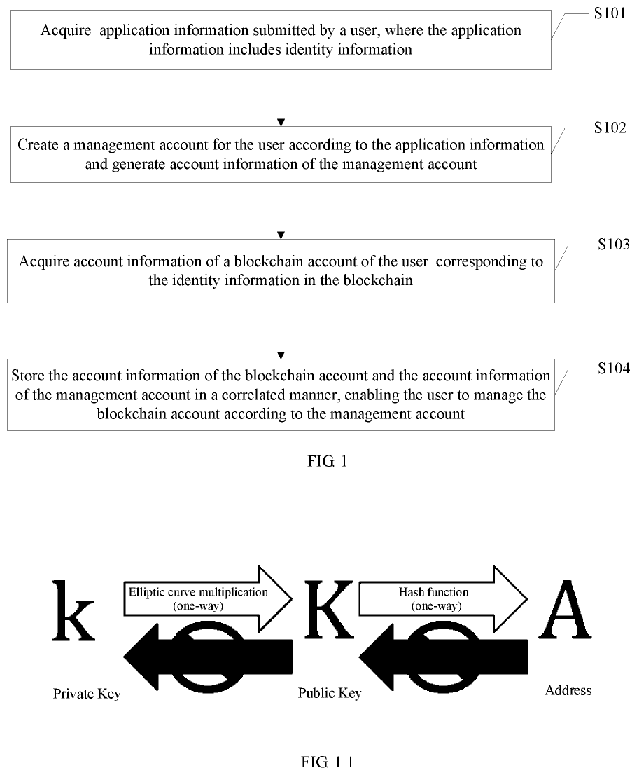

FIG. 1 is a flowchart of implementing a multi-chain information management method according to an embodiment of the present disclosure. In this embodiment, the multi-chain information management method is applied to a blockchain identity parser and will be described in detail as follows. The method includes steps S101 to S104 and the specific implementation principles of the respective steps are as follows.

In S101, application information submitted by a user is acquired, where the application information includes identity information.

The application information includes a user name, identity information, and password information. In the embodiment of the present disclosure, the user name is customized by the user instead of being generated according to an algorithm, thereby facilitating user memorizer. Specifically, the user name needs to meet the user name customization requirement, for example, the number of bytes, preset by the blockchain identity parser. The identity information is the information that can be used to identify the user. In this embodiment, the identity information includes one or more of a mobile phone number, an email account, and a social contact account number. The password information includes an account password set by the user, and the password information needs to meet a password customization requirement preset by the blockchain identity parser.

In S102, a management account for the user is created according to the application information, and account information of the management account is generated.

Specifically, the management account refers to an account of the user for the blockchain identity parser, and the blockchain identity parser is configured to store the account information of the blockchain account of the user for each blockchain. The management account is associated with the account information of the blockchain account.

Optionally, as an embodiment of the present disclosure, the step of S102 specifically includes A1 to A4.

In A1, a management account for the user is created according to the application information, where the account information of the management account includes a management public key, a management private key, and a management address.

In A2, the management private key is generated according to the application information of the user and a first preset algorithm. Specifically, the first preset algorithm may be a random algorithm, and the management private key is randomly generated for the user according to the application information of the user.

In A3, the management public key is generated based on the management private key and a second preset algorithm. Specifically, the second preset algorithm may be an elliptic curve algorithm. The management public key can be acquired by calculating the management private key by an elliptic curve algorithm. The elliptic curve cryptography is an asymmetric (or public key) cryptography based on the discrete logarithm problem, which can be expressed by adding or multiplying the points on an elliptic curve.

In A4, the management address is generated based on the management public key and a third preset algorithm. The third preset algorithm may be a hash function algorithm, and the management address is acquired according to the management public key and the hash function algorithm.

Specifically, the public key can be calculated from the private key by the elliptic curve algorithm, which is an irreversible process. The calculation formulation may be K=k*G, where k is the management private key, G is a constant point called a generation point, and K is the management public key. Its reverse operation, called “finding discrete logarithms”, that is, acquiring the private key k from the known public key K, is very difficult, just like trying all possible k values, i.e. violent search. It should be noted that, as shown in FIG. 1.1, in the embodiment of the present disclosure, the management public key acquired according to the management private key, and the management address acquired according to the management public key are both acquired by one-way calculation and cannot be acquired by reverse calculation, thus ensuring the security of the management private key.

Optionally, the specific step of generating the management address based on the management public key and the hash function algorithm includes A41 to A46.

In A41, the SHA256 hash value of the management public key is calculated to acquire the first value. Specifically, the hash value is used as a unique value representing a fixed size of a large amount of data. A small amount of change in data can produce unpredictable large change in the hash value. The hash value of the SHA256 algorithm is 256 bits.

In A42, the RIPEMD-160 hash value of the first value is calculated to acquire a second value. Specifically, the RIPEMD (RACE Original Integrity Check Message Digest) is a cryptographic hash function, and the RIPEMD-160 is a 160-bit version modified from the original RIPEMD and is the most common version of the RIPEMD series.

In A43, a version number of the management address is acquired and combined with the second value to acquire a third value.

In A44, the SHA256 hash value of the third value is calculated to acquire a fourth value.

In A45, a value corresponding to the specified byte in the fourth value is acquired, and the value corresponding to the specified byte is jointed with the third value to acquire a first initial management address.

In A46, the first initial management address is encoded to acquire the first management address. Specifically, base 58 encoding is performed on the first initial management address to acquire the first management address. The Base 58 is a unique encoding method used in Bitcoin.

Optionally, as an embodiment of the present disclosure, a step A47 is included after the step A44 in the method.

In A47, the SHA256 hash value of the fourth value is calculated to acquire a fifth value.

Here, the step of A45 includes:

a value corresponding to the specified byte in the fifth value is acquired, and the value corresponding to the specified byte in the fifth value is jointed with the third value to acquire a second initial management address.

Here, the step of A46 includes:

the second initial management address is encoded to acquire the second management address.

Illustratively, the randomly generated management public key is:

0450863AD64A87AE8A2FE83C1AF1A8403CB53F53E486D8511DAD8A04887E5B2352 2CD470243453A299FA9E77237716103ABC11A1DF38855ED6F2EE187E9C582BA6;

In the first step, the SHA-256 hash value of the management public key is calculated.

600FFE422B4E00731A59557A5CCA46CC183944191006324A447BDB2D98D4B408;

In the second step, the result of the first step is used to calculate the RIPEMD-160 hash value:

010966776006953D5567439E5E39F86A0D273BEE;

In the third step, the management address version number 0x00 is acquired and added in front of the result of the second step:

00010966776006953D5567439E5E39F86A0D273BEE;

In the fourth step, the result of the third step is used to calculate the SHA-256 hash value:

445C7A8007A93D8733188288BB320A8FE2DEBD2AE1B47F0F50BC10BAE845C094;

In the fifth step, the result of the fourth step is used to calculate the SHA-256 hash value:

D61967F63C7DD183914A4AE452C9F6AD5D462CE3D277798075B107615C1A8A30;

In the sixth step, the first 4 bytes (8-bit hexadecimal) D61967F6 of the result of the fifth step are taken and added after the result of the third step, being used as verification, and the initial management address (This is the hexadecimal form of the address) is acquired as verification:

00010966776006953D5567439E5E39F86A0D273BEED61967F6

In the seventh step, the initial management address is transformed by using the base 58 algorithm to acquire the management address: 16UwLL9Risc3QfPqBUvKofHmBQ7wMtjvM.

In S103, the account information of the blockchain account of the user corresponding to the identity information in the blockchain is acquired.

Specifically, if the user submits a blockchain account creation request including identity information, and applies for a blockchain account for the blockchain, it is determined whether a blockchain account for the blockchain corresponding to the identity information exists. If exists, the account information of the blockchain account of the user for the blockchain corresponding to the identity information of the user is acquired.

As an embodiment of the present disclosure, the step of S103 specifically includes:

receiving the account information of the blockchain account of the user sent from the blockchain corresponding to the identity information, where the account information of the blockchain account is triggered to be sent after the blockchain creates the account for the user according to the account application information of the user. The account information of the blockchain account includes, but is not limited to, a public key and an address. In the embodiment of the present disclosure, when the user applies the blockchain account for the blockchain by using the account information of the management account, the blockchain will send the account information of the blockchain account to the blockchain identity parser according to the management address in the account information of the management account.

In the embodiment of the present disclosure, the account information of the blockchain account of the user for the blockchain is automatically synchronized to the blockchain identity parser by the blockchain.

Optionally, as an embodiment of the present disclosure, the step of S103 specifically includes B1 and B2.

In B1, a message received by a specified account in a blockchain corresponding to the identity information is detected, where the specified account is pre-created in the blockchain according to the account information of the management account of the user.

In B2, if it is detected that the specified account in the blockchain receives the message sent from the blockchain account of the user in the blockchain, the account information of the blockchain account is acquired.

Specifically, the blockchain identity parser performs monitoring detection on the specified account in the blockchain, and if it is detected that the specified account in the blockchain receives the message sent from the blockchain account of the user in the blockchain, the account information of the blockchain account is acquired. In the embodiment of the present disclosure, if the blockchain does not synchronously send the account information of the blockchain account to the blockchain identity parser, it is determined that the users of the blockchain account and the management account are the same by means of being added into to a block. Specifically, the blockchain identity parser creates a specified account X in the blockchain in advance according to the management account. When the blockchain account A of the first user in the blockchain makes a transaction to the specified account X (which may also be sending a message), and the transaction is packaged into the blockchain, i.e. if the specified account X receives the transaction information acquisition message from the blockchain account A, it is determined that the first user owns the blockchain account A in the blockchain. If the message sent by the blockchain account is received, it is proved that the first user and the user corresponding to the management account are the same user.

In S104, the account information of the blockchain account and the account information of the management account are stored in a correlated manner, enabling the user to manage the blockchain account according to the management account.

In the embodiment of the present disclosure, a mapping relationship between the account information of the management account and the account information of the blockchain account is established. The mapping relationship includes a mapping relationship between the management public key and the public key and a mapping relationship between the management address and the address. In the embodiment of the present disclosure, the same management account may correspond to a blockchain account in more than one blockchains, and the same management account may correspond to multiple blockchain accounts in the same blockchain, and the account information of the same management account may correspond to the account information of the blockchain accounts in more than one blockchain at the same time.

Optionally, in the embodiment of the present disclosure, the blockchain identity parser may alternatively be in the form of a blockchain wallet, and the user creates a blockchain account for each blockchain through the blockchain identity parser. It should be noted that, in this embodiment, the blockchain identity parser needs to acquire the rule for creating accounts for respective blockchains.

It can be seen that, in some embodiments of the present disclosure, the application information including the identity information submitted by the user is acquired, the management account is created for the user according to the application information, the account information of the management account is generated, the account information of the blockchain account of the user in the blockchain corresponding to the identity information is acquired, and the account information of the blockchain account and the account information of the management account are stored in a correlated manner, enabling the user to manage the blockchain account according to the management account. The user only needs to memorize the account information of the management account, and does not need to separately memorize the account information in respective blockchains, thereby reducing the burden of the user and improving the efficiency of the operation of the user to the blockchain.

It should be understood that, value of serial number of the steps in the aforesaid embodiment doesn't mean a sequencing of execution sequences of the steps, the execution sequence of each of the steps should be determined by functionalities and internal logics of the steps themselves, and shouldn't be regarded as limitation to an implementation process of the embodiment of the present disclosure.

### Embodiment 2

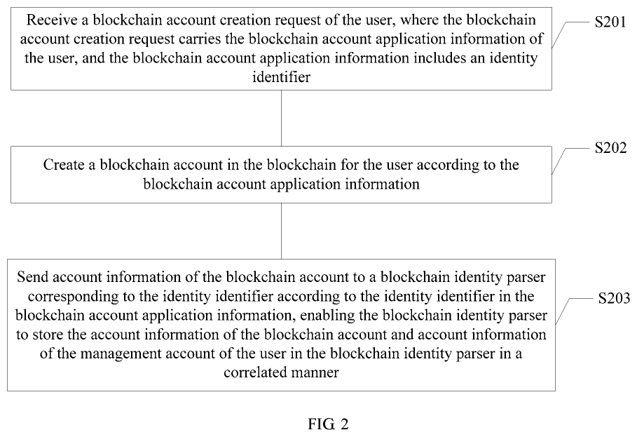

FIG. 2 is a flowchart of implementing a multi-chain information management method according to an embodiment of the present disclosure. In this embodiment, the multi-chain information management method is applied to a blockchain and will be described in detail as follows. The method includes steps S201 to S203. The specific implementation principles of respective steps are as follows.

In step S201, a blockchain account creation request of the user is received, where the blockchain account creation request carries a blockchain account application information of the user, and the blockchain account application information includes an identity identifier.

The identity identifier is also used to identify a user. In the embodiment of the present disclosure, the blockchain account application information of the user carried by the blockchain account creation request may include the account information of the management account of the user.

In step S202, a blockchain account is created in the blockchain for the user according to the blockchain account application information.

The account information of the blockchain account includes an account, a public key, and an address. Further, the user may choose to upload his private key to the management account. In the embodiment of the present disclosure, the account information is extensible. With the development of the blockchain, the account information will be more and more. For example, in the EOS blockchain, the account information includes owner accounts, active accounts and creator accounts etc.

In step S203, the account information of the blockchain account is sent to a blockchain identity parser corresponding to the identity identifier according to the identity identifier in the blockchain account application information, enabling the blockchain identity parser to store the account information of the blockchain account and account information of a management account of the user in the blockchain identity parser in a correlated manner.

Optionally, as an embodiment of the present disclosure, the step of S203 specifically includes C1 and C2.

In C1, it is determined, according to the identity identifier in the blockchain account application information, whether the user has a management account.

In C2, if the user has a management account, account information of the blockchain account is sent to a blockchain identity parser corresponding to the identity identifier, enabling the blockchain identity parser to store the account information of the blockchain account and account information of the management account in a correlated manner.

Specifically, in the embodiment of the present disclosure, if the blockchain determines that the user has a management account, it is determined that the account information of the blockchain account should be associated with the account information of the management account, the blockchain sends the account information of the blockchain account to the blockchain identity parser corresponding to the identity identifier, enabling the blockchain identity parser to store the account information of the blockchain account and account information of a management account of the user in the blockchain identity parser in a correlated manner, that is, the mapping relationship between the account information of the blockchain account and the account information of the management account is established by the blockchain identity parser.

Optionally, as an embodiment of the present disclosure, the step of S203 specifically includes D1 to D3.

In D1, a specified account of the blockchain identity parser corresponding to the identity identifier in the blockchain is acquired according to the identity identifier in the blockchain account application information.

In D2, a message is sent to the specified account based on the blockchain account. Specifically, the blockchain account is an account to be bound to the management account in the blockchain.

In D3, the blockchain performs message monitoring on the specified account, and if the specified account receives the information sent by the blockchain account, the blockchain sends the account information of the blockchain account to the blockchain identity parser corresponding to the identity identifier, enabling the blockchain identity parser to store the account information of the blockchain account and account information of a management account of the user in the blockchain identity parser in a correlated manner.

Specifically, according to the public key and the address, a block with the information of the management public key is posted in the blockchain, and it proves that the users corresponding to the public key and the management public key are the same user. Illustratively, the user causes the public key x1 of the blockchain account to transfer transactions in the blockchain to the public key x0 in the blockchain specified by the blockchain identity parser, where x0 is the public key specifically applied by the blockchain identity parser in the blockchain according to the management public key sx. If the transfer transaction is added in a block in the blockchain, it is proved that the user owns the public key x1 of the blockchain and the private key corresponding to the public key x1, thereby associating the management public key sx with the public key x1 of the blockchain account, and the account information such as the public key and the address of the blockchain account is sent to the blockchain identity parser, the blockchain identity parser stores the mapping relationship between the account information of the management account and the account information of the blockchain account of the blockchain. Further, the transaction amount of the transfer transaction is the transaction amount input by the user when the blockchain identity parser is bound, and if the transaction amount matches, the binding is performed. The transaction amount is optional.

Illustratively, the step of S203 specifically includes: according to the application information to be bound by the management account A (binding the account Y for the blockchain C), creating a specified account X in a certain blockchain C to be bound. The management account A trades in the blockchain C with the own account Y to the specified account X (it is also possible to send a message). If the transaction information (Y→X) of the above transaction is posted to the blocks of the blockchain C, the account information of the blockchain account and the account information of the management account in the blockchain identity parser are associated with the account.

It can be seen that, in the embodiment of the present disclosure, the blockchain receives a blockchain account creation request of the user, the blockchain account creation request carries the blockchain account application information of the user, the blockchain account application information includes an identity identifier, a blockchain account is created in the blockchain for the user according to the blockchain account application information, and account information of the blockchain account is sent to a blockchain identity parser corresponding to the identity identifier according to the identity identifier in the blockchain account application information, enabling the blockchain identity parser to store the account information of the blockchain account and account information of a management account of the user in the blockchain identity parser in a correlated manner, enabling the user to manage the blockchain account according to the management account. The user only needs to memorize the account information of the management account, and does not need to separately memorize the account information in respective blockchains, thereby reducing the burden of the user and improving the efficiency of the operation of the user to the blockchain.

It should be understood that, value of serial number of the steps in the aforesaid embodiment doesn't mean a sequencing of execution sequences of the steps, the execution sequence of each of the steps should be determined by functionalities and internal logics of the steps themselves, and shouldn't be regarded as limitation to an implementation process of the embodiment of the present disclosure.

### Embodiment 3

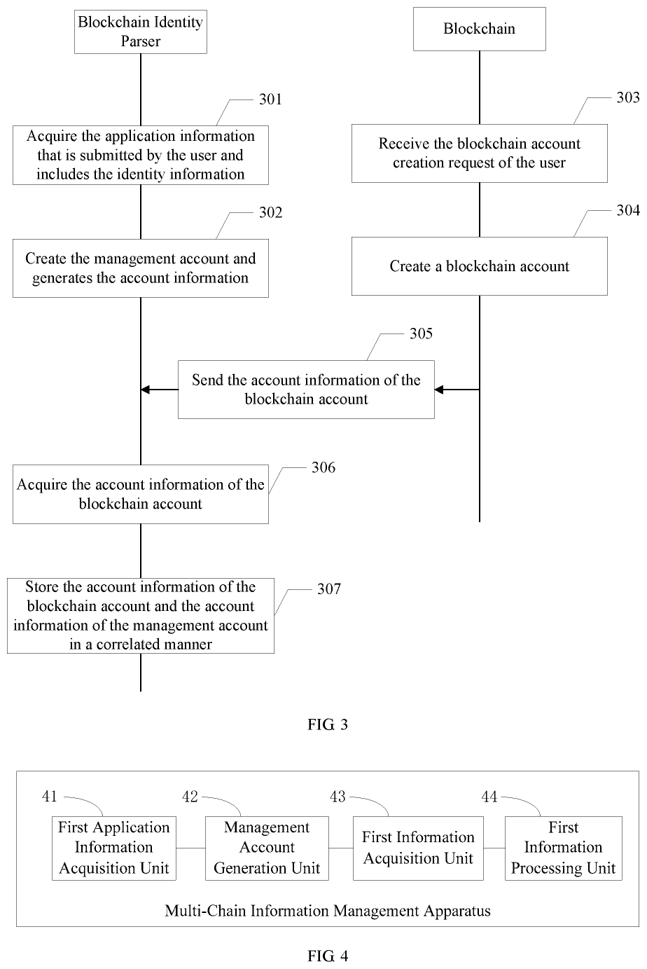

FIG. 3 is a schematic diagram of an interaction process of a multi-chain information management method according to an embodiment of the present disclosure. The execution body participating in the interaction process includes the blockchain identity parser and the blockchain. The implementation principle of the interaction process is consistent with the implementation principle of each execution body side described in FIG. 1 and FIG. 2, so only the interaction process is briefly described and the details are not described herein.

In S301, the blockchain identity parser acquires the application information that is submitted by the user and includes the identity information.

In S302, the blockchain identity parser creates the management account for the user according to the application information and generates the account information of the management account.

In S303, the blockchain receives the blockchain account creation request of the user, where the blockchain account creation request carries the blockchain account application information of the user, and the blockchain account application information includes an identity identifier.

In S304, the blockchain creates a blockchain account in the blockchain for the user according to the blockchain account application information.

In S305, the blockchain sends the account information of the blockchain account to the blockchain identity parser corresponding to the identity identifier.

In S306, the blockchain identity parser acquires the account information of the blockchain account of the user in the blockchain corresponding to the identity information.

In S307, the blockchain identity parser stores the account information of the blockchain account and the account information of the management account which are associated with each other by the blockchain identity parser.

It can be seen that, in some embodiments of the present disclosure, the application information including the identity information submitted by the user is acquired, the management account is created for the user according to the application information, the account information of the management account is generated, the account information of the blockchain account of the user in the blockchain corresponding to the identity information is acquired, and the account information of the blockchain account and the account information of the management account are stored in a correlated manner, enabling the user to manage the blockchain account according to the management account. The user only needs to memorize the account information of the management account, and does not need to separately memorize the account information in respective blockchains, thereby reducing the burden of the user and improving the efficiency of the operation of the user to the blockchain.

It should be understood that, value of serial number of the steps in the aforesaid embodiment doesn't mean a sequencing of execution sequences of the steps, the execution sequence of each of the steps should be determined by functionalities and internal logics of the steps themselves, and shouldn't be regarded as limitation to an implementation process of the embodiment of the present disclosure.

### Embodiment 4

FIG. 4 is a block diagram of a multi-chain information management apparatus 4 according to an embodiment of the present disclosure. The multi-chain information management apparatus 4 is applicable to the blockchain identity parser described above and is used to implement the multi-chain information management method described in FIGS. 1 to 4 of the present disclosure. For the convenience of explanation, only the parts related to the present embodiment are shown.

Referring to FIG. 4, the multi-chain information management apparatus 4 includes a first application information unit acquisition unit 41, a management account generation unit 42, a first information acquisition unit 43, and a first information processing unit 44, where:

the first application information acquisition unit 41 is configured to acquire application information submitted by the user, where the application information includes identity information;

the management account generation unit 42 is configured to create a management account for the user according to the application information, and to generate account information of the management account;

the first information acquisition unit 43 is configured to acquire the account information of the blockchain account of the user in the blockchain corresponding to the identity information; and

the first information processing unit 44 is configured to store the account information of the blockchain account and the account information of the management account which are associated with each other, so that the user manages the blockchain account according to the management account.

Optionally, the management account generation unit 42 includes:

a first account creation module, configured to create a management account for the user according to the application information, where the account information of the management account includes a management public key, a management private key, and a management address;

a first information generating module, configured to generate the management private key according to the application information of the user and a first preset algorithm;

a second information generating module, configured to generate the management public key based on the management private key and a second preset algorithm; and

a third information generating module, configured to generate the management address based on the management public key and a third preset algorithm.

Optionally, the first information acquisition unit 43 includes:

an information detecting module, configured to detect a message received by a specified account in a blockchain corresponding to the identity information, where the specified account is pre-created in the blockchain according to the account information of the management account of the user; and

a first information acquisition module, configured to acquire the account information of the blockchain account if it is detected that the specified account in the blockchain receives the message sent from the blockchain account of the user in the blockchain.

Optionally, the first information acquisition unit 43 includes:

an account information receiving module, configured to receive the account information of the blockchain account of the user sent from the blockchain corresponding to the identity information, where the account information of the blockchain account is triggered to be sent after the blockchain creates the account for the user according to the account application information of the user.

It can be seen that, in some embodiments of the present disclosure, the blockchain identity parser acquires the application information including the identity information submitted by the user, creates the management account for the user according to the application information, generates the account information of the management account, acquires the account information of the blockchain account of the user in the blockchain corresponding to the identity information, and stores the account information of the blockchain account and the account information of the management account in a correlated manner, enabling the user to manage the blockchain account according to the management account. The user only needs to memorize the account information of the management account, and does not need to separately memorize the account information in respective blockchains, thereby reducing the burden of the user and improving the efficiency of the operation of the user to the blockchain.

### Embodiment 5

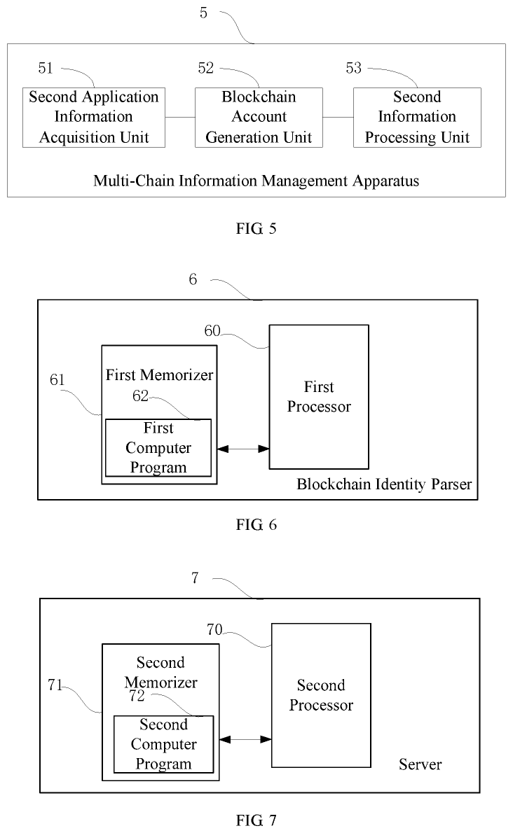

FIG. 5 is a block diagram of another multi-chain information management apparatus 5 according to an embodiment of the present disclosure. The multi-chain information management apparatus 5 is applicable to the blockchain identity parser described above and is used to implement the multi-chain information management method described in FIG. 1 to FIG. 3 of the present disclosure. For the convenience of explanation, only the parts related to the present embodiment are shown.

Referring to FIG. 5, the multi-chain information management apparatus 5 includes a second application information acquisition unit 51, a block chain account generation unit 52, and a second information processing unit 53, where:

the second application information acquisition unit 51 is configured to receive a blockchain account creation request of the user, where the blockchain account creation request carries the blockchain account application information of the user, and the blockchain account application information includes an identity identifier;

the blockchain account generation unit 52 is configured to create a blockchain account in the blockchain for the user according to the blockchain account application information; and

the second information processing unit configured to send account information of the blockchain account to a blockchain identity parser corresponding to the identity identifier according to the identity identifier in the blockchain account application information, enabling the blockchain identity parser to store the account information of the blockchain account and account information of a management account of the user in the blockchain identity parser in a correlated manner.

Optionally, the second information processing unit 53 includes:

an information judging module, configured to determine, according to the identity identifier in the blockchain account application information, whether the user has a management account;

a first information processing module, configured to send the account information of the blockchain account to a blockchain identity parser corresponding to the identity identifier if the user has a management account, enabling the blockchain identity parser to store the account information of the blockchain account and account information of a management account of the user in the blockchain identity parser in a correlated manner.

Optionally, the second information processing unit 53 includes:

an account information acquisition module, configured to acquire, according to the identity identifier in the blockchain account application information, a specified account of the blockchain identity parser corresponding to the identity identifier in the blockchain;

a message sending module, configured to send a message to the specified account based on the blockchain account; and

a second information processing module, configured to: if the specified account receives the information sent by the blockchain account, the blockchain sends the account information of the blockchain account to the blockchain identity parser corresponding to the identity identifier, enabling the blockchain identity parser to store the account information of the blockchain account and account information of a management account of the user in the blockchain identity parser in a correlated manner.

It can be seen that, in the embodiment of the present disclosure, the blockchain receives a blockchain account creation request of the user, the blockchain account creation request carries the blockchain account application information of the user, the blockchain account application information includes an identity identifier, a blockchain account is created in the blockchain for the user according to the blockchain account application information, and account information of the blockchain account is sent to a blockchain identity parser corresponding to the identity identifier according to the identity identifier in the blockchain account application information, enabling the blockchain identity parser to store the account information of the blockchain account and account information of a management account of the user in the blockchain identity parser in a correlated manner, enabling the user to manage the blockchain account according to the management account. The user only needs to memorize the account information of the management account, and does not need to separately memorize the account information in respective blockchains, thereby reducing the burden of the user and improving the efficiency of the operation of the user to the blockchain.

### EXAMPLE 6

FIG. 6 is a schematic diagram of a blockchain identity parser according to an embodiment of the present disclosure. As shown in FIG. 6, the blockchain identity parser 6 of this embodiment includes a first processor 60, a first memorizer 61, and a first computer program 62, such as a multi-chain information management program, stored in the first memorizer 61 and can be run in the first processor 60. When the first processor 60 executes the first computer program 62, the steps in respective embodiments of the above-described multi-chain information management method, for example, steps S101 to S104 shown in FIG. 1, are implemented. Alternatively, when the first processor 60 executes the first computer program 62, the functions of the modules/units in respective embodiments of the above-described apparatus, such as the functions of the units 41 to 44 shown in FIG. 4, are implemented. Specifically, the first processor 60 implements the following steps by running the first computer program 62 stored in the first memorizer 61:

acquiring application information submitted by the user, where the application information includes identity information;

creating a management account for the user according to the application information, and to generate account information of the management account;

acquiring account information of a blockchain account of the user corresponding to the identity information in the blockchain; and

storing the account information of the blockchain account and the account information of the management account in a correlated manner, enabling the user to manage the blockchain account according to the management account.

Illustratively, the first computer program 62 can be divided into one or more modules/unit, the one or more modules/units is stored in the first memorizer 61 and executed by the first process 60 to realize the application. The one or more modules/unit may be a series of first computer program instruction segments capable of performing a particular function, the instruction segments are used to describe the implementation process of the first computer program 62 in the blockchain identity parser 6.

The blockchain identity parser 6 may include, but is not limited to, a first processor 60 and a first memorizer 61. It will be understood by those skilled in the art that FIG. 6 is only an example of the blockchain identity parser 6, and does not constitute a limitation on the blockchain identity parser 6, and the blockchain identity parser may include more or less components than the illustration, or combine certain components, or include different components. For example, the blockchain identity parser may also include input or output devices, a network access device, a bus and the like.

The first processor 60 may be a central processing unit (CPU), or may be other general purpose first processor, a digital signal first processor (DSP), an application specific integrated circuit (ASIC), a Field-Programmable Gate Array (FPGA) or other programmable logic devices, discrete gate or transistor logic devices, discrete hardware components, etc. The general purpose first processor may be a micro first processor or the first processor may be any conventional first processor or the like.

The first memorizer 61 may be an internal storage unit of the blockchain identity parser 6, such as a hard disk or memorizer of the blockchain identity resolver 6. The first memorizer 61 may alternatively be an external storage device of the blockchain identity parser 6, for example, a plug-in hard disk equipped on the blockchain identity resolver 6, a smart memorizer card (SMC), a secure digital (SD) card, or a Flash Card, etc. Further, the first memorizer 61 may alternatively include both an internal storage unit of the blockchain identity parser 6 and an external storage device. The first memorizer 61 is configured to store the first computer program 62 and other programs and data required by the blockchain identity parser. The first memorizer 61 may also be configured to temporarily store the data that has been output or is about to be output.

It can be seen that, in some embodiments of the present disclosure, the blockchain identity parser acquires the application information including the identity information submitted by the user, creates the management account for the user according to the application information, generates the account information of the management account, acquires the account information of the blockchain account of the user in the blockchain corresponding to the identity information, and stores the account information of the blockchain account and the account information of the management account in a correlated manner, enabling the user to manage the blockchain account according to the management account. The user only needs to memorize the account information of the management account, and does not need to separately memorize the account information in respective blockchains, thereby reducing the burden of the user and improving the efficiency of the operation of the user to the blockchain.

### Embodiment 7

FIG. 7 is a schematic diagram of a server according to an embodiment of the present disclosure. As shown in FIG. 7, the server 7 according to this embodiment includes a second processor 70, a second memorizer 71, and a second computer program 72, such as a multi-chain information management program, stored in the first memorizer 71 and can be run in the second processor 70. When the second processor 70 executes the second computer program 72, the steps in respective embodiments of the above-described multi-chain information management method, for example, steps S201 to S203 shown in FIG. 2, are implemented. Alternatively, when the second processor 70 executes the second computer program 72, the functions of the modules/units in respective embodiments of the above-described apparatus, such as the functions of the units 51 to 53 shown in FIG. 5, are implemented. Specifically, the second processor 70 implements the following steps by running the second computer program 72 stored in the second memorizer 71:

receiving a blockchain account creation request of the user, where the blockchain account creation request carries the blockchain account application information of the user, and the blockchain account application information includes an identity identifier;

creating a blockchain account in the blockchain for the user according to the blockchain account application information; and

sending account information of the blockchain account to a blockchain identity parser corresponding to the identity identifier according to the identity identifier in the blockchain account application information, enabling the blockchain identity parser to store the account information of the blockchain account and account information of a management account of the user in the blockchain identity parser in a correlated manner.

Illustratively, the second computer program 72 can be divided into one or more modules/unit, the one or more modules/units is stored in the second memorizer 71 and executed by the second process 70 to realize the application. The one or more modules/unit may be a series of second computer program instruction segments capable of performing a particular function, the instruction segments are used to describe the implementation process of the second computer program 72 in the server 7.

The server 7 may include, but is not limited to, a second processor 70 and a second memorizer 71. It will be understood by those skilled in the art that FIG. 7 is only an example of the server 7, and does not constitute a limitation on the server 7, and the server may include more or less components than the illustration, or combine certain components, or include different components. For example, the blockchain identity parser may also include input or output devices, a network access device, a bus and the like.

The second processor 70 may be a central processing unit (CPU), or may be other general purpose second processor, a digital signal second processor (DSP), an application specific integrated circuit (ASIC), a Field-Programmable Gate Array (FPGA) or other programmable logic devices, discrete gate or transistor logic devices, discrete hardware components, etc. The general purpose second processor may be a micro second processor or the second processor may be any conventional second processor or the like.

The second memorizer 71 may be an internal storage unit of the server 7, such as a hard disk or memorizer of the server 7. The second memorizer 71 may alternatively be an external storage device of the server 7, for example, a plug-in hard disk equipped on the server 7, a smart memorizer card (SMC), a secure digital (SD) card, or a Flash Card, etc. Further, the second memorizer 71 may alternatively include both an internal storage unit of the server 7 and an external storage device. The second memorizer 71 is configured to store the second computer program 72 and other programs and data required by the server. The second memorizer 71 may also be configured to temporarily store the data that has been output or is about to be output.

It can be seen that, in the embodiment of the present disclosure, the blockchain receives a blockchain account creation request of the user, the blockchain account creation request carries the blockchain account application information of the user, the blockchain account application information includes an identity identifier, a blockchain account is created in the blockchain for the user according to the blockchain account application information, and account information of the blockchain account is sent to a blockchain identity parser corresponding to the identity identifier according to the identity identifier in the blockchain account application information, enabling the blockchain identity parser to store the account information of the blockchain account and account information of a management account of the user in the blockchain identity parser in a correlated manner, enabling the user to manage the blockchain account according to the management account. The user only needs to memorize the account information of the management account, and does not need to separately memorize the account information in respective blockchains, thereby reducing the burden of the user and improving the efficiency of the operation of the user to the blockchain.

In addition, the various functional units in each of the embodiments of the present application can be integrated into a single processing unit, or exist individually and physically, or two or more than two units are integrated into a single unit. The aforesaid integrated unit can either be achieved by hardware, or be achieved in the form of software functional units.

If the integrated unit is achieved in the form of software functional units, and is sold or used as an independent product, it can be stored in a computer readable storage medium. Based on this understanding, a whole or part of flow process of implementing the method in the aforesaid embodiments of the present application can also be accomplished by using computer program to instruct relevant hardware. When the computer program is executed by the processor, the steps in the various method embodiments described above can be implemented. Wherein, the computer program comprises computer program codes, which can be in the form of source code, object code, executable documents or some intermediate form, etc. The computer readable medium can include: any entity or device that can carry the computer program codes, recording medium, USB flash disk, mobile hard disk, hard disk, optical disk, computer storage device, ROM (Read-Only Memory), RAM (Random Access Memory), electrical carrier signal, telecommunication signal and software distribution medium, etc. It needs to be explained that, the contents contained in the computer readable medium can be added or reduced appropriately according to the requirement of legislation and patent practice in a judicial district, for example, in some judicial districts, according to legislation and patent practice, the computer readable medium doesn't include electrical carrier signal and telecommunication signal.

As stated above, the aforesaid embodiments are only intended to explain but not to limit the technical solutions of the present application. Although the present application has been explained in detail with reference to the above-described embodiments, it should be understood for the ordinary skilled one in the art that, the technical solutions described in each of the above-described embodiments can still be amended, or some technical features in the technical solutions can be replaced equivalently; these amendments or equivalent replacements, which won't make the essence of corresponding technical solution to be broken away from the spirit and the scope of the technical solution in various embodiments of the present application, should all be included in the protection scope of the present application.

1. A multi-chain information management method for a blockchain identity parser, comprising:
acquiring application information submitted by a user, wherein the application information includes identity information;
creating a management account for the user according to the application information and generating account information of the management account;
acquiring account information of a blockchain account of the user corresponding to the identity information in a blockchain; and
storing the account information of the blockchain account and the account information of the management account in a correlated manner enabling the user to manage the blockchain account according to the management account.

2. The multi-chain information management method of claim 1, wherein the step of acquiring account information of a blockchain account of the user in a blockchain corresponding to the identity information comprises:
receiving the account information of the blockchain account of the user sent from the blockchain corresponding to the identity information, wherein the account information of the blockchain account is triggered to be sent after the blockchain creates an account for the user according to an account application information of the user.

3. The multi-chain information management method of claim 1, wherein the step of acquiring account information of a blockchain account of the user in a blockchain corresponding to the identity information comprises:
detecting a message received by a specified account in the blockchain corresponding to the identity information, wherein the specified account is pre-created in the blockchain according to the account information of the management account of the user; and
acquiring the account information of the blockchain account if it is detected that the specified account in the blockchain receives the message sent from a blockchain account of the user in the blockchain.

4. The multi-chain information management method of claim 1, wherein the step of creating a management account for the user according to the application information and generating account information of the management account comprises:
creating a management account for the user according to the application information, wherein account information of the management account includes a management public key, a management private key, and a management address;
generating the management private key according to application information of the user and a first preset algorithm;
generating the management public key based on the management private key and a second preset algorithm; and
generating the management address based on the management public key and a third preset algorithm.

5. A multi-chain information management method for a blockchain, comprising:
receiving a blockchain account creation request of a user, wherein the blockchain account creation request carries a blockchain account application information of the user, and the blockchain account application information includes an identity identifier;
creating a blockchain account in the blockchain for the user according to the blockchain account application information; and
sending account information of the blockchain account to a blockchain identity parser corresponding to the identity identifier according to the identity identifier in the blockchain account application information, enabling the blockchain identity parser to store the account information of the blockchain account and account information of a management account of the user in the blockchain identity parser in a correlated manner.

6. The multi-chain information management method of claim 5, wherein the step of sending account information of the blockchain account to a blockchain identity parser corresponding to the identity identifier according to the identity identifier in the blockchain account application information comprises:
determining, according to the identity identifier in the blockchain account application information, whether the user has a management account; and
sending account information of the blockchain account to a blockchain identity parser corresponding to the identity identifier if the user has a management account, enabling the blockchain identity parser to store the account information of the blockchain account and account information of the management account in a correlated manner.

7. The multi-chain information management method of claim 5, wherein the step of sending account information of the blockchain account to a blockchain identity parser corresponding to the identity identifier according to the identity identifier in the blockchain account application information comprises:
acquiring a specified account of a blockchain identity parser corresponding to the identity identifier in the blockchain according to the identity identifier in the blockchain account application information;
sending a message to the specified account based on the blockchain account; and
sending, by the blockchain, account information of the blockchain account to the blockchain identity parser corresponding to the identity identifier if the specified account receives an information sent by the blockchain account, enabling the blockchain identity parser to store the account information of the blockchain account and account information of the management account in a correlated manner.

8. (canceled)

9. A blockchain identity parser, comprising a first memorizer, a first processor and a first program stored in the first memorizer and operable in the first processor, wherein the first processor is configured to implement steps of the multi-chain information management method according to claim 1 when executing the first computer program.

10. A computer readable and writable storage medium with a first computer program stored therein, wherein when the first computer program is executed by a first processor, steps of the multi-chain information management method according to claim 1 are implemented.

11. The multi-chain information management method of claim 2, wherein the step of creating a management account for the user according to the application information and generating account information of the management account comprises:
creating a management account for the user according to the application information, wherein account information of the management account includes a management public key, a management private key, and a management address;
generating the management private key according to application information of the user and a first preset algorithm;
generating the management public key based on the management private key and a second preset algorithm; and
generating the management address based on the management public key and a third preset algorithm.

12. The multi-chain information management method of claim 3, wherein the step of creating a management account for the user according to the application information and generating account information of the management account comprises:
creating a management account for the user according to the application information, wherein account information of the management account includes a management public key, a management private key, and a management address;
generating the management private key according to application information of the user and a first preset algorithm;
generating the management public key based on the management private key and a second preset algorithm; and
generating the management address based on the management public key and a third preset algorithm.

13. The multi-chain information management method of claim 6, wherein the step of sending account information of the blockchain account to a blockchain identity parser corresponding to the identity identifier according to the identity identifier in the blockchain account application information comprises:
acquiring a specified account of a blockchain identity parser corresponding to the identity identifier in the blockchain according to the identity identifier in the blockchain account application information;
sending a message to the specified account based on the blockchain account; and
sending, by the blockchain, account information of the blockchain account to the blockchain identity parser corresponding to the identity identifier if the specified account receives an information sent by the blockchain account, enabling the blockchain identity parser to store the account information of the blockchain account and account information of the management account in a correlated manner.
